(19) United States
(12) Patent Application Publication
(10) Pub. No.: US 2005/0028133 A1
(43) Pub. Date: Feb. 3, 2005

(54) System and method for rapid design, prototyping, and implementation of distributed scalable architecture for task control and automation

(76) Inventors: Viswanath Ananth, Norristown, PA (US); Andy Suri, Lansdale, PA (US)

Correspondence Address: EDWARD ETKIN, ESQ, 4804 BEDFORD AVE # 3C, BROOKLYN, NY, 11235, US

(21) Appl. No.: 10/911,161

(22) Filed: Aug. 2, 2004

Related U.S. Application Data
(60) Provisional application No. 60/492,771, filed on Aug. 2, 2003.

(51) Int. Cl. G06F 9/44

(52) U.S. Cl. 717/105; 717/138

(57) ABSTRACT

The present invention provides a system and method for simplifying and accelerating the process of prototyping, real-world simulation, and implementation of virtually any task performance system or device, thereby dramatically reducing the design-to-implementation cycle time and expense. The inventive system includes a development system that provides a user, with visual tools to interactively and dynamically partition a previously designed visual system model of the task performance system or device, and then interactively or automatically assign the partitions to corresponding selectable target components, to produce a prototyped system ready for conversion to executable form suitable for implementation. The inventive system and method can also be readily used to automatically generate any instruction sets that are necessary for implementing the prototyped task performance system in actual target components of one or more emulation and/or production target systems. A novel automatic executable program code generation process that can be advantageously utilized is also provided in accordance with the present invention. Finally, the present invention may optionally include a data handling device that enables real-time monitoring and management of a remote target system from one or more user systems, as well as a set of tools for designing interactive visual instrument panels for that purpose.

### CROSS REFERENCE TO RELATED APPLICATIONS

The present patent application claims priority from the commonly assigned U.S. provisional patent application Ser. No. 60/492,771 entitled “SYSTEM AND METHOD FOR RAPID DESIGN, PROTOTYPING AND IMPLEMENTATION OF DISTRIBUTED SCALABLE ARCHITECTURE FOR TASK CONTROL AND AUTOMATION” filed Aug. 2, 2003.

### FIELD OF THE INVENTION

The present invention relates generally to a data processing system for modeling and implementation of scalable distributed systems that perform various tasks, and more particularly to a scalable architecture-based data processing system for simplified design, prototyping, and rapid implementation of task performance systems, including, but not limited to, industrial process control systems, other embedded systems, multi-component electrical, electronic, or electromechanical devices, and distributed computer systems.

### BACKGROUND OF THE INVENTION

Traditionally, the process of design, prototyping and implementation of complex industrial applications (such as manufacturing process control, multi-component devices and other systems or devices), has been an extremely difficult, costly and time consuming task. Typically, this process involved a long iterative, and often empirical, process, of formulating the requirements of the desired system, conceptually planning the system, developing a prototype, writing programs or other code necessary for implementation, testing the implemented prototype and then repeating many of the steps, in most cases including the arduous and frustrating coding of new programs, even when minor changes to the prototype are necessary. In cases of more serious issues, the entire system is often re-designed further consuming a great deal of time and resources. This trial and error approach of system and device design has been a challenge for engineers and designers for years.

However, as data processing systems came into increased use in the last several decades, attempts have been made to automate and simplify at least some of the steps involved in system design, prototyping, and implementation, both for design of new systems and for modification, re-engineering and improvement of existing industrial systems. Thus, as data processing (i.e. computer) systems have gained increased utilization in the field of system and device design, a great deal of effort was directed toward providing engineers and system designers with powerful software tools that simplify the difficult goal of designing and modeling a system (e.g., industrial, computer, process control, etc.) or an apparatus (e.g., automobile exhaust system, engine, motor, etc.) in a software environment. The ultimate goal of these tools was to enable the user (e.g., the engineer) to design a software model of the desired system, simulate the model to ensure proper system operation, and hopefully assist the user in implementing the modeled system in real-world devices.

Nevertheless, even with the aid of currently available powerful software tools, prototyping of a complex system or apparatus which generally requires a distributed architecture for its various operational parameters (such as an industrial process control application), it is a difficult and time consuming process with at least the following steps that must be performed by the user as part of the design to implementation cycle:

1) Design the desired target system functionality;

2) Break down the target system manually into distributed target components requiring slight modification in design, model each component and their connections separately to correspond to a real-world target device or system, and assign a portion of the desired functionality to each component, and establish connections between appropriate components;

3) Write appropriate software code to cause each component to perform their assigned functionality as well as to ensure proper communication and data interchange between various components

3) Simulate the operation of the system, testing and monitoring one component at a time; and

4) Manage the system (i.e., issue commands such as start, stop, record progress or status), one component at a time.

5) If problems occur, repeat one or more of the previous steps until the target system performs acceptably.

Because the key actions for all of the above tasks must be performed manually by the user, even with the assistance of the most powerful currently available design tools, the design-to-implementation cycle in continuous product development industries (such as automotive and aerospace industries), remains undesirably long. In addition, changes to the system architecture or to system components during the prototyping process must be manually propagated through the entire system, thus resulting in a further significant delay and expense. Furthermore, the most frustrating and difficult tasks for the user of previously known system design software tools—the second and third steps shown above—are still an ever-present requirement. Thus, the user must still engage in the manual and time-intensive partitioning of the designed system into multiple components corresponding to various real-world hardware systems and writing a great deal of code each time a change to any aspect of the system must be made (e.g., moving an element of a model to a different partition to relieve the load on a target component), but now utilizing an attractive graphical user interface to do so. And with many design systems, after the design and prototype modeling process is complete, appropriate software code must be manually generated for each target system component.

The above issues are due at least in part to the fact that the great deal of the advancements in the system design and modeling tools have been directed to improvements of preliminary system design capabilities, for example to provide users with innovative and easy to use graphical design tools, to enable visual concept-to-design model development, and to otherwise shorten the concept-to-design cycles, to enable improved computerized design simulation. Others directed their research and development to offering improvements and innovations in hardware target components, resulting in relatively inexpensive and powerful embedded system target components that may be utilized to emulate real-world physical components or that may be used as production target components themselves. Accordingly, the area between the two has been largely neglected or ignored. Finally, the majority of existing design software tools are generally limited to utilization in the field of embedded system design and cannot be readily used in other forms of distributed task performance systems.

It would thus be desirable to provide a system and method for simplifying the processes of virtually any task performance system or device prototyping and implementation, and thereby reducing the design-to-implementation cycle time. It would also be desirable to provide an integrated system and method that may be used as a tool by itself or in conjunction with existing visual system design tools for rapid and inexpensive design, prototyping, re-design, scaling, modification, and/or testing of task performance systems. It would further be desirable to provide a system and method for automatically generating necessary code for implementing the designed task performance systems. It would additionally be desirable to provide a system and method for enabling the user to utilize an available existing graphical user interface for improving the ease and speed of the task performance system prototyping and implementation processes.

### BRIEF DESCRIPTION OF THE DRAWINGS

In the drawings, wherein like reference characters denote corresponding or similar elements throughout the various figures:

FIG. 1 shows a block diagram of an exemplary embodiment of the rapid design prototyping and implementation (RDPI) system used with a previously designed visual system model that executes one or more novel processes in accordance with the present invention;

FIGS. 2 and 3 show diagrams representative of exemplary embodiments of a target system of FIG. 1;

FIG. 4 shows a diagram of an exemplary target attribute record that may be associated with components of the target system of FIG. 1

FIG. 5 shows a process flow diagram of process steps performed by the RDPI system of FIG. 1 in conjunction with input from a user thereof, in accordance with the present invention to rapidly transform the visual system model into a prototype model and/or a set of corresponding executable modules for implementation in a desired target system;

FIGS. 6 and 7 show process flow diagrams representative of exemplary embodiments of portions of the inventive process of FIG. 5 that relate to partitioning of the visual system model in accordance with the present invention.

FIGS. 8 through 10 are block diagrams that illustrate the progression of a visual system model to a partially partitioned model and finally to a fully partitioned model during performance of the processes of FIGS. 5 and FIG. 6 or FIG. 7;

FIGS. 11 to 12 show a process flow diagram, and a related exemplary supporting diagram, of an inventive process for automatically generating executable modules for implementation in a desired target system from the partitioned system model, during the execution of the process of FIG. 5;

FIG. 13 shows a schematic diagram of an inventive data handling system for real-time monitoring and management of an implemented target system from a remote user system;

FIG. 14 shows a diagram representative of an inventive user interface that may be implemented in the RDPI system of FIG. 1 to design an interactive reconfigurable visual instrument panel that me be used for real-time remote monitoring and management one or more target systems; and

FIG. 15 shows a diagram representative of an exemplary visual instrument panel that may be designed using the interface of FIG. 14.

### SUMMARY OF THE INVENTION

The present invention is directed to a system and method for simplifying and accelerating the process of prototyping, real-world simulation, and implementation of virtually any task performance system or device, thereby dramatically reducing the design-to-implementation cycle time and expense. The inventive system includes a development system that provides a user, with visual tools to interactively and dynamically partition a previously designed visual system model of the task performance system or device, and then interactively or automatically assign the partitions to corresponding selectable target components, to produce a prototyped system ready for conversion to executable form suitable for implementation. The inventive system and method can also be readily used to automatically generate any instruction sets (e.g. programs, drivers, or modules) that are necessary for implementing the prototyped task performance system in actual target components of one or more emulation and/or production target systems. A novel automatic executable program code generation process that can be advantageously utilized is also provided in accordance with the present invention.

In summary, the inventive system delivers the above functionality via a development system (that may range in features and other aspects from a pocket computer to a network of powerful computers) that interactively executes one or more novel processes in response to user commands that may be issued through the system's graphical user interface. If implementation of the prototyped task performance system is desired, the novel system may be connected to a target system to implement therein, executable code modules representative of the prototyped system, that were generated during the performance of one or more novel processes.

Advantageously, the inventive processes performed by the system of the present invention, are applicable to any visual system model that may be created with any form of visual design and/or modeling tools. While the inventive system may be readily implemented in a stand-alone configuration independent of any other design or modeling tools or environments, as a matter of design choice, it may be utilized in conjunction with existing visual system design tools for rapid and inexpensive design, prototyping, re-design, scaling, modification, and/or testing of task performance systems. This approach is very attractive because the user is able utilize an available and familiar graphical user interface and controls of the initial design system and at the same time use all of the novel features and capabilities provided in accordance with the present invention.

The system of the present invention may include an optional data handling system located as a component of, or proximal to, the implementation target system for enabling real time transmission of date from the target system to a remote development or other user system. Furthermore, the development system of the present invention, may be provided with an interactive user interface, at its output (i.e. display) system with novel tools and functionality that enable the user to readily design an interactive reconfigurable visual instrument panel for monitoring and/or management one or more remote target systems or devices.

Due to the novel features of the present invention, the prototyped model (or even the visual design model) may be quickly and easily modified at any time, for example, to account for changes in design or engineering requirements, target system factors, or to take advantage of new technologies, and/or lower-cost target components, without requiring the user to extensively re-design the visual model, or to write any program code.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The system and method of the present invention remedy the disadvantages of all previously known system design software tools. In essence, the inventive rapid design, prototyping, and implementation (hereinafter “RDPI”) system gives its user the ability to quickly and easily move from a designed visual model of a task control and/or performance system or apparatus, that may be created with any form of visual design and/or modeling tools, to a real-time interactive prototype model representative of the actual desired real-world system or apparatus (hereinafter “target system”). The user may then utilize the RDPI system to automatically generate and/or assemble any instruction modules and necessary support modules based on the prototype model, that may be directed to a physical real-world target system, corresponding to the prototype model, to implement the designed task performance system or apparatus for desired utilization.

Advantageously, due to the novel features of the present invention, the interactive prototype model (or even the visual design model) may be quickly and easily modified at any time, for example, to account for changes in design or engineering requirements, target system factors, or to take advantage of new technologies, and/or lower-cost target components, without requiring the user to extensively re-design the visual model, or to write any program code. This is a crucial advantage in any design/prototyping process, especially for complex systems, where ordinarily many expensive and time consuming re-design and prototyping iterations would need to take place as a matter of course. Thus, in contrast to previously known design tools, the inventive RDPI system enables real-time interactive modification of a prototype model, or of the visual design model (depending on the scope of the desired changes), and subsequent optional automatic instruction module generation for target system implementation, so that the newly modified target system may be readily utilized.

Other advantages of the RDPI system, are its scalable architecture and visual design tool/platform independence. Because the RDPI system can work with any visual model in any format (if necessary, with simple utilization of appropriate readily available conversion tools) it may be readily used in a virtually unlimited range of application in various industries, from automotive design and/or manufacturing to home automation systems, or home electronics.

Moreover, the RDPI system's scalable architecture enables the user to work with designed visual models for target systems of any scope from a simple electrical or electromechanical devices with two or more components, or an internal combustion engine, to complex automated manufacturing facilities or distributed computer or telecommunication networks with hundreds or thousands of components.

In summary, the RDPI system advantageous accomplishes its goals by:
Providing the user with information representative of the attributes of the various target components available for use in target system prototyping;
Enabling the user to interactively “partition” the visual design system, by assigning one or more designed visual model actions and/or parameters, (for example, “blocks”, if the visual model is a block diagram) into individual “partitions”, where each partition represents the desired functionality of a particular corresponding target system component, and then automatically generating the partitions and establishing the appropriate types of communication links between partitions that correspond to flow of information and/or instructions between target system components in the target system;
Or, optionally, automatically partitioning and optimizing the visual design system based on predefined partitioning rules, and then suggesting a proposed partitioned system model to the user for approval or modification; and
Once the partitioned system is approved by the user, generating all necessary instruction modules (and, if necessary, generating and/or assembling support modules) that are issued to the target system for rapid implementation of the designed system therein.

Thus, the inventive RDPI system significantly automates and simplifies the prototyping process there by reducing design, prototyping and implementation expenses and shortening the design to implementation cycle. Furthermore, the inventive system provides a scalable and flexible architecture that with a minimum of effort enables scalability of the designed system in different implementation configurations, and also enables simplified modification of an existing designed system (for changing, re-engineering or upgrading the system).

In particular, the inventive RDPI system provides many significant advantages in industries with continuous or long-term product development cycles, such as in the automotive and airspace industries (for example, in vehicle development or development of manual, semi-autonomous, or autonomous systems).

While the inventive RDPI system is described below as advantageously configured, by way of example, for industrial process (or process control) design and for distributed embedded systems, it should be understood to one skilled in the art, that, as noted above, the RDPI system may be readily and advantageously utilized for prototyping and implementation of any system or device with two or more functioning components capable of receiving instructions, including, but not limited to process control systems, automated industrial systems (fabrication, packaging, sorting, etc), distributed electromechanical systems, embedded systems of various functionalities (control and otherwise), electrical devices, electromechanical devices, and distributed computational systems, for example, for massive computational processes such as military, research, or meteorological applications, without departing from the spirit of the invention as a matter of necessity or design choice.

Before describing the inventive RDPI system in greater detail, it would be helpful to provide an overview of the various types of target systems that may be designed and implemented in accordance with the present invention, and of the various target components that may be utilized therein. The simplest target system may include as little as two target components, but a more complex target system may include a far greater number of target components as a matter of design choice. While an actual real-world target system or device may have many physical components, such as a housing, mechanical elements such as gears, or other features, the inventive RDPI system is only concerned with functional components of the target system that are capable of performing one or more actions in response to internal instructions or received commands. The target components themselves can vary from simple to complex.

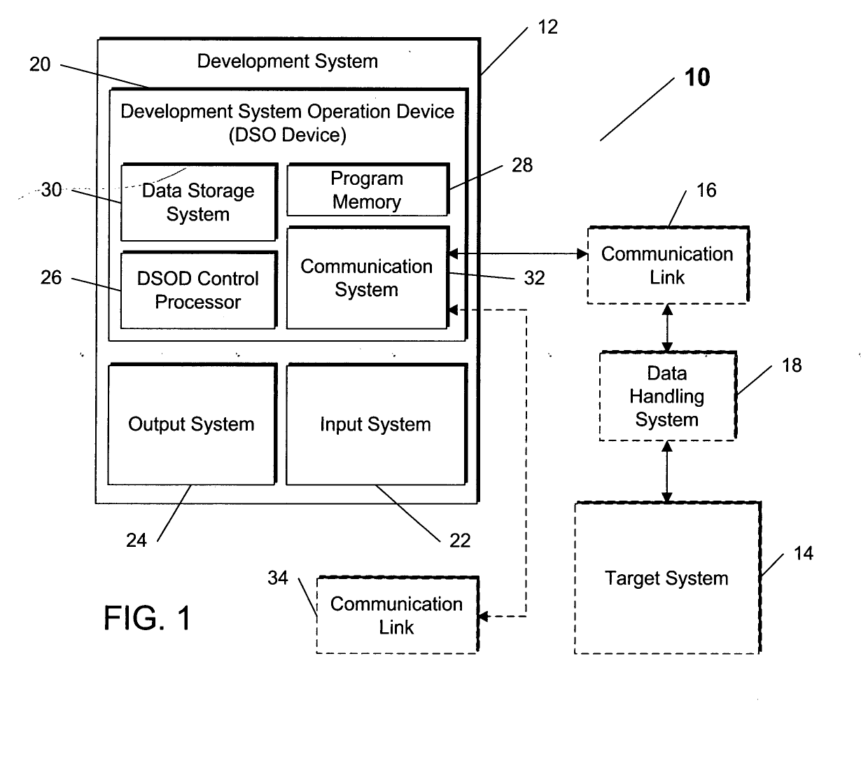

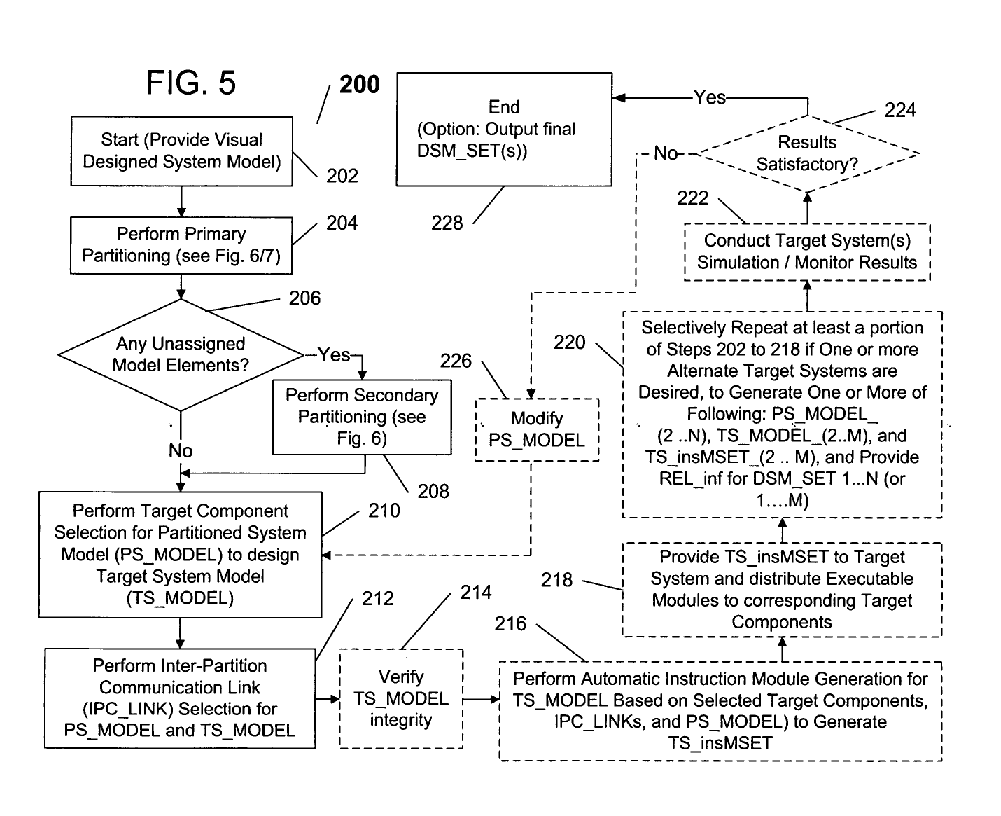

Referring now to FIG. 1, a first embodiment of the inventive RDPI system 10 is shown. The key novel features of the RDPI system 10 are embodied in the inventive processes, described in greater detail below in connection with FIGS. 5-7 and 12, that may be implemented in whole or in part as one or more executable programs or other form of data processing tasks. These inventive processes enable the user to fully utilize the previously summarized novel and advantageous features of the RDPI system 10, as well as take advantage of numerous other novel features and options described below in connection with various figures.

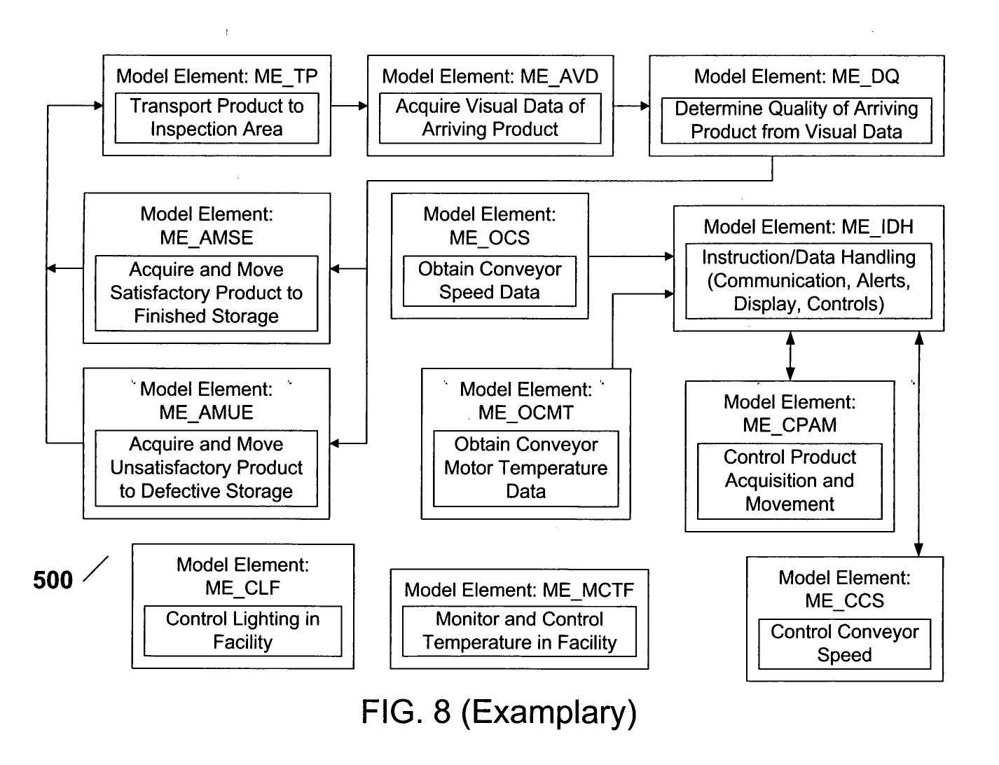

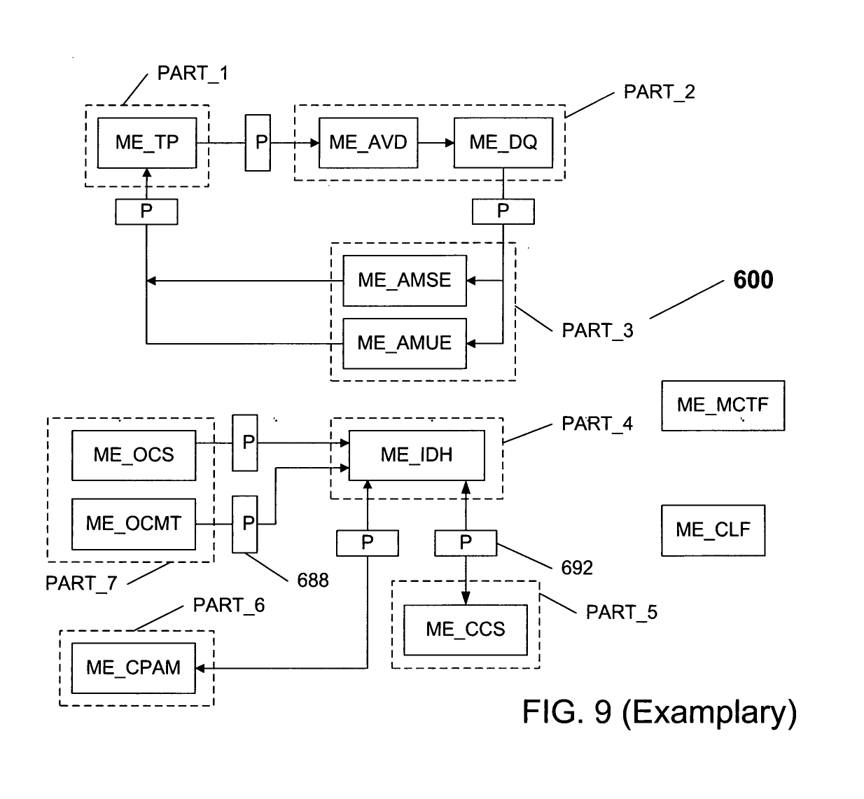

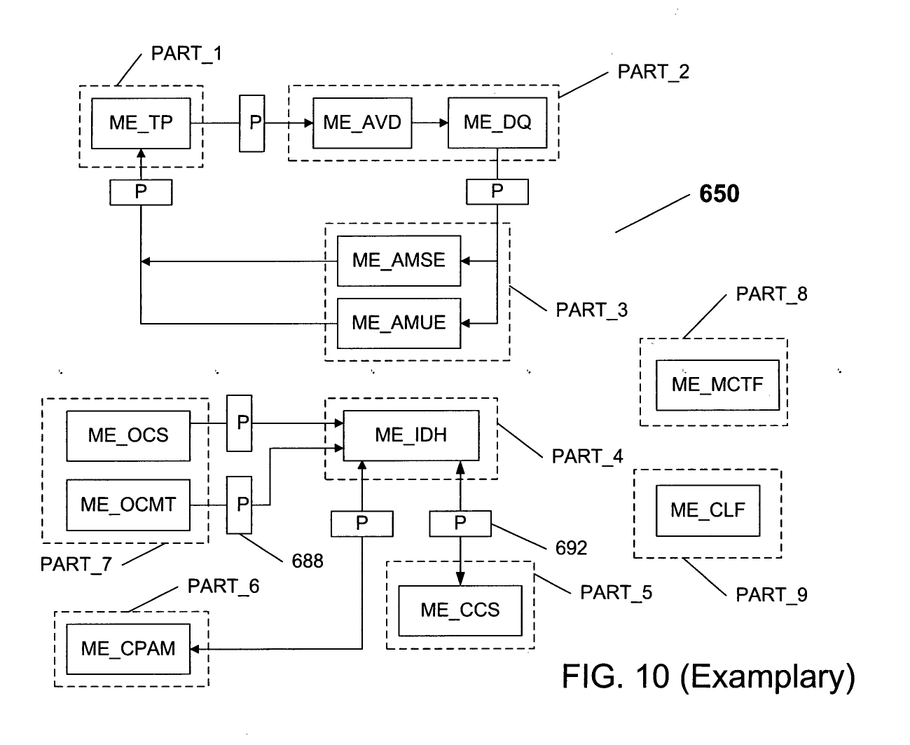

The RDPI system 10 includes a development system 12 for enabling the user to quickly and easily create an operational system model (representative of a previously designed visual system model partitioned into individual model elements and/or model element groups (i.e., “partitions”) intended for assignment to particular target components, as well as the necessary communication links therebetween), and to create a target system model in which the partitions are assigned to selected target components for future implementation. The RDPI system 10 may also include an optional target system 14, if implementation of the operational system model created by the user is desired. An exemplary previously designed visual system model is described below in connection with FIG. 8, while a corresponding exemplary operational system model is described in connection with FIGS. 9 and 10.

The development system 12 may be any interactive device or system capable of enabling the user to work with a previously designed visual system model, to create a desired target system model, and to optionally generate the instruction modules necessary for its implementation, for example, if implementation in an optional target system 14 is available. Thus, at a minimum, the development system 12 is preferably capable of:
Interacting with a previously designed visual system model,
performing one or more inventive processes and any required associated operations,
providing the user with an interactive visual interface,
providing the user with the ability to control its operation and the inventive processes, and
if implementation in the target system 14 is desired, communicating with a target system to issue the necessary instruction models to the target system.

For example, the development system 12 may be any computer system with at least the above-listed capabilities, including, but not limited to: a small computer (e.g. a pocket computer or equivalent), a portable computer (e.g., a notebook or touchpanel computer, or equivalent), a workstation (or equivalent), or a terminal of a local or remote computer system. As a matter of design choice, the development system 12, may be capable of performing other tasks, in addition to those that are required by the RDPI system 10, or for example, it may be a dedicated or proprietary system optimized for meeting the RDPI system 10 demands. Optionally, the development system 12 may be implemented as two or more interconnected computer systems, to either distribute the task load imposed by the RDPI system 10 or to allow two or more users to collaborate on the design and prototyping process.

The development system 12 includes the following elements (that may be separate components connected to one or more other components, or that may be integrated with one or more of the other components as a single unit): a DSO device 20 for controlling the various components of the development system 12, executing performing one or more inventive processes, executing other programs, storing data, and equivalent tasks, an input system 22 for receiving instructions and information from the user, and an output system 24 for conveying information to the user.

The DSO device 20 is preferably a main computer assembly or unit that may include, but is not limited to:
a DSOD control processor 26 and associated hardware for running an operating system, for executing application programs (including for example, a least portion of the RDPI system 10 inventive processes in from of executable application programs), and otherwise controlling operation of all other components of the development system 12;
a program memory 28, such as random access memory (RAM) or equivalent, for temporarily storing data, program instructions and variables during the execution of application programs by the DSOD control processor 26;
a data storage system 30, such as flash memory, optical, magnetic, or magneto-optical drives, or equivalent, for long term storage of data and application programs (optionally if the program memory 28 is of sufficient size and reliability, the functions of the data storage system 30 may be incorporated therein; and
a communication system 32, such as a modem, a communication network interface device, or equivalent, for transmitting to, and receiving data from another system through a communication link (e.g. a network, a direct line, etc.).

The output system 24 preferably includes a display system for displaying visual information to the user, such as one or more monitors, an optional sound system, such as speakers or headphones, and an optional hard copy system, such as a printer, or equivalent.

The input system 22 preferably includes at least one data input device for enabling the user to interact with the development system 12. For example, the input system 24 includes one or more of the following input devices: a keyboard, a selection device (i.e. mouse, trackball, or touchpad), an optionally a voice recognition device. Optionally, the input system 22 may include a security system (for example, a biometric device such as a fingerprint scanner, face recognition device, or a retinal scanner) for receiving identity verification data from the user prior to allowing the user to utilize the RDPI system 10. For example, it may be a biometric device such as a fingerprint scanner, face recognition device, or a retinal scanner.

It should be understood that the choice of a specific type or configuration of the development system 12, and its types and features of its various components, is determined by requirements that depend on the purposes for which the RDPI system 10 will be used (e.g., the complexity of the system being designed, whether or not the user wishes to generate instruction modules for implementation, etc.)

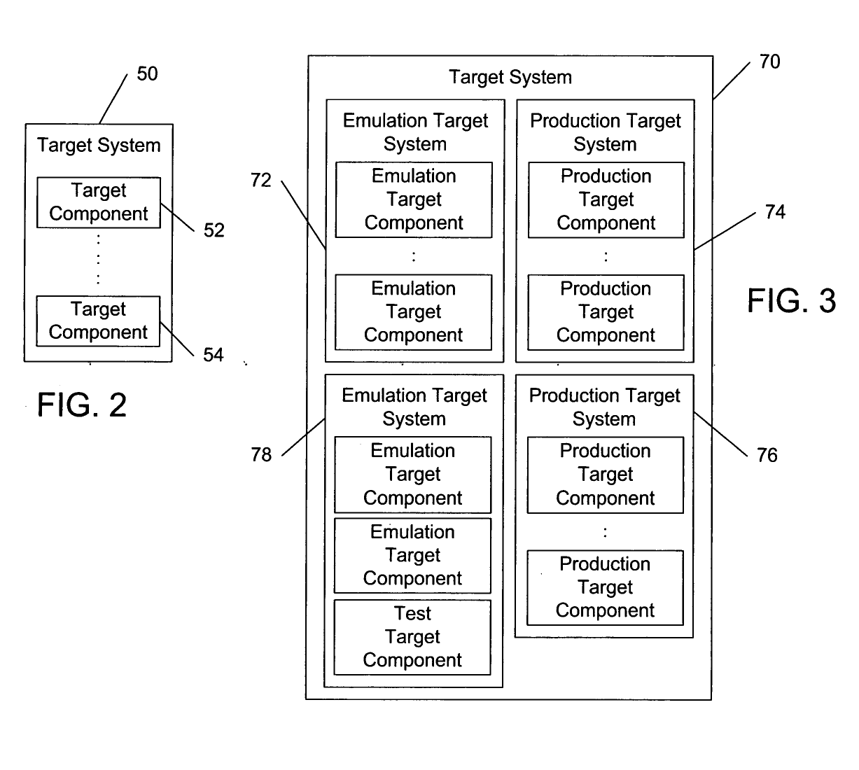

The optional target system 14 may be any target system configured to correspond to a target system model created by the user utilizing the development system 12. Various types and configurations of target systems are described above, and several exemplary target systems are discussed below in connection with FIGS. 2 and 3.

It should be understood, that the key goals of the present invention—greatly accelerating and simplifying the task of system prototyping, design and preparation for implementation, do not rely on the availability of the target system 14. The target system 14 is only necessary if implementation of instruction modules generated from the operational and target system models at the development system 12 is necessary or desired. Thus, it should be understood that the entire RDPI system 10 may be implemented solely in the development system 12, as a mater of design choice or necessity, without departing from the spirit of the invention. nevertheless, to provide a better overview of the novel features of the present invention, it would be convenient to presume, by way of example, that the optional target system 14 is present for the purpose of the discussion of the inventive RDPI system 10.

The development system 12 communicates with the target system 14 via a communication link 16, which may be any communication link that enables bi-directional transmission of information. Examples of communication links 16 that may readily be utilized include, but are not limited to, one or more of the following: direct connection, the Internet, local area network (LAN), wide area network (WAN), Intranet, dial-up network, and wireless network (e.g., infrared, cellular, satellite, radio, or a network using any other wireless communication method). Thus, in practice, the development system 12 and the target system 14 may be connected to one another directly (for example if the target system 14 is at the user's location (or vice versa), or they be geographically separated, as long as they can communicate with one another.

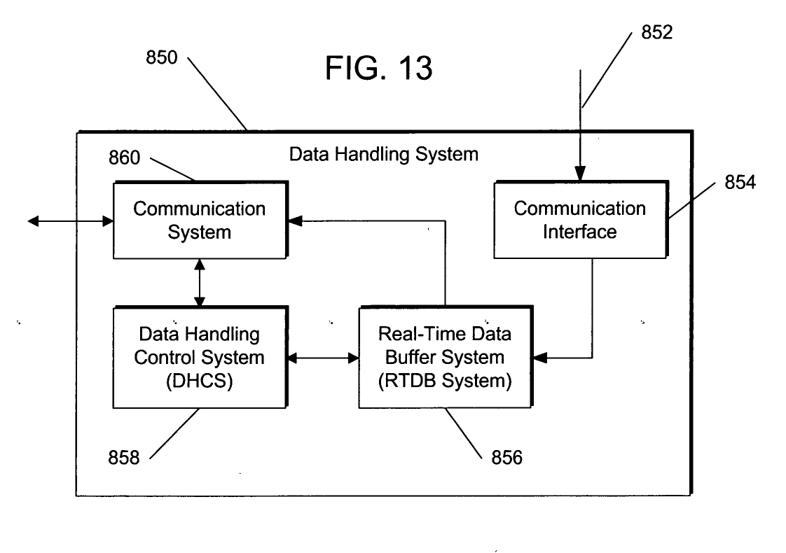

Optionally, if future monitoring and/or management of an implemented target system 14 is desired (for example, to test the target system model developed at the development system 12 as part of the prototyping process), a novel data handling system 18 may be provided as part of, or as an interface to, the target system 14 to ensure guaranteed real-time communication from the target system 14 without any loss of data even during monitoring/management of a complex data system with a massive adapt output. Referring now to FIG. 13, the date handling system 18 is shown as an exemplary data handling system 850. The data handling system 850 receives data from the target system 14 via a data link 852, which then enters a novel real-time data buffer RTDB system 856 which is connected to a data handling control system (DHCS) 858 for receiving commands therefrom, and for sending alerts and logs thereto, and also to a communication system 860 for forwarding the guaranteed real time data stream to the development system 12 via a data link 854 that communicates with the system 12 through the communication link 16.

In contrast to previously known systems in which only discrete periodic target system snap-shots were sent to the user, or in which only a single component of a target system could be monitored or managed in real-time, the technique of the present invention enables the target system to continuously generate a real-time data stream limited only by the rated capacity of the RTDB system 856. The RTDB system 856 is the key feature of the data handling system 850, in that, it uses a group of two or more physical or logical buffers (or a combination thereof) to ensure that none of the data arriving from the link 852 is dropped or lost.(unless the entire system completely fails). This is accomplished by recording the data stream in one buffer until a predetermined transfer point is reached in which case the next buffer begins simultaneously recording the data stream. When the fact that the second buffer has started recording is verified, the RTDB system 856 stops recording data in the first buffer, and transmits the data recorded in the buffer before the transfer point and also any data present in its dual recording region which may have been recoded during the time between the predetermined transfer point and the time the next buffer actually started recording the stream. This ensures that even of there is a delay in switching between buffers, not data is lost.

The DHCS 858 may be optionally provided with additional features, for example with diagnostic procedures to test the RTDB system 856 periodically, or immediately preceding or following its use. Another useful novel feature of the DHCS 858 is a data preservation function which enables the DHCS 858 to close buffers that failed a certain amounts of time in a row.

Returning now to FIG. 1, the development system 12 may also be connected to an optional second communication link 34 (which may be of the same or different type as the communication link 16) for communication with another development system or with another target system (for example if the target system 14 is local and directly connected to the development system 12, through the communication link 16 in form of a cable, a connection to another target system (not shown) in a remote location requires the development system 12 to connect through an alternate communication link 34 (such as a network).

Referring now to FIGS. 2 and 3, several exemplary embodiments of the target system 14 of FIG. 1 are shown. Referring first to FIG. 2, an exemplary basic configuration embodiment of a target system 14 is shown as a target system 50. The target system 50 includes at least two target components, 52 and 54 in the simplest configuration, but may include a far greater number of target components as a matter of design choice. The target components can vary from simple, such as temperature sensor, to very complex multi-function embedded systems in their own right, such as a programmable controller or an industrial robot.

As described above, while an actual real-world target system or device may have many physical components, the RDPI system 10 works with the functional target components (e.g., target components 52, 54) of the target system 50 that are capable of performing one or more actions in response to internal instructions or received commands. The target components themselves can vary from simple to complex. For example, the target component 52 may be a simple temperature sensor, while the target component 54 may be a programmable controller that performs a number of tasks and issues a number of commands to other target systems in response to a particular temperature reading received from the target component 52.

It should be noted that, because a target component (e.g., target component 52) may in itself be a full multi-component system, a particular complex target system may in fact contain a number of other target systems as its components, and those systems may include target systems acting as target components as well, and so on. In fact, this may be a necessary approach when designing very complex systems.

Under certain circumstances, after completion of a prototype design model of a target system 14 and generation of the necessary target system instruction modules, it may not be desirable or feasible, for a variety of reasons, to test these modules in an actual production system. This may be the case if the user designing the system has no access to the actual necessary target Components, or does not wish to utilize production target components, for example, if testing the designed system in production components is dangerous or prohibitively expensive in case of damage to the component due to a design flaw or other type of error. In such cases, it may be desirable to utilize, as a substitute, one or more emulation target components—devices that are capable of emulating the features, outputs, responses to inputs, and other attributes, of the corresponding production target component. For example, an emulation target system may be entirely comprised of emulation target components to test the instruction modules for a designed target system in the safety of a lab or a workshop and at minimal investment.

Furthermore, if the purpose of the prototyping process conducted using the RDPI system 10 is to design and test one or more target components for a particular target system 14, an emulation target system may be specifically configured with the desired production components to be tested, and one or more emulation target components that represent and emulate the production target components in the future final production target system.

Referring now to FIG. 3, an exemplary complex embodiment of a target system 14 is shown as a target system 70, that depicts, by way of example, the various types of target systems discussed above as target components of the system 70 in themselves. Thus, the target system 70 may include one or more of: an emulation target system 72 having only emulation target components; two production target systems 74 and 76, having only production target components in each, and an emulation target system 78, that includes both emulation target components and one or more test target components (i.e. production target component(s) being tested).

As noted above, utilization of the novel RDPI system requires certain information about the target components that are available to the user when designing the target system. For a particular target component, this information can range from very simple list of target capabilities, I/O signals and required protocols to communicate with other target components, to a detailed and comprehensive record that includes additional target information such as rules for using this component with other components, values for physical characteristics, installation requirements, and even the cost or lead time for purchasing the component. This information is preferably stored by the RDPI system 10 and made available to the user during the design/prototyping process. The type, quantity, and scope/detail of target component information may be dependent on the complexity and nature of the system or device being designed and prototyped, on whether a particular target component is a production or emulation component, or on other factors, such as the desired precision, the level of control being made available to the user by superiors, or simply on the availability of the information about a particular target component.

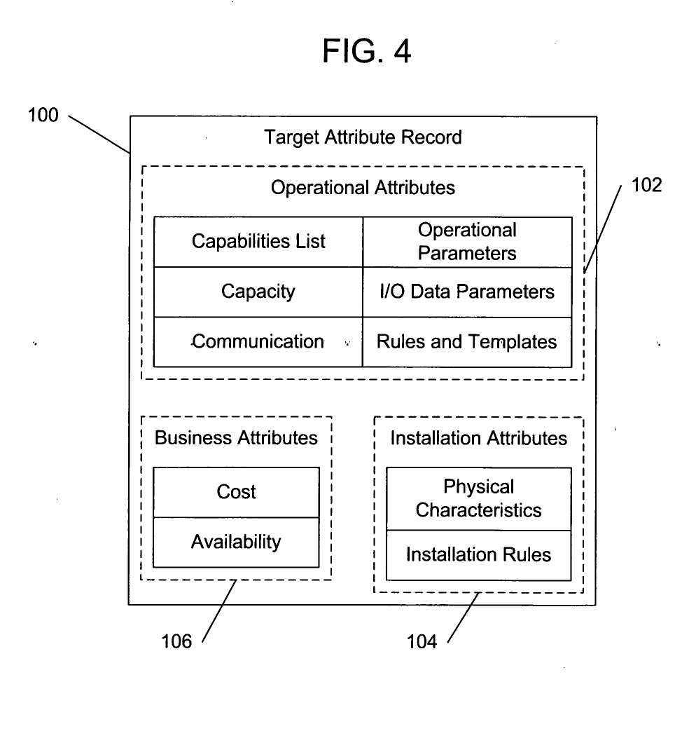

Referring now to FIG. 4, a representation of the scope of possible information (i.e., target attributes), that may be available about a target component of the target system 14, is shown as an exemplary target attribute record 100. The target attribute record 100 may include attributes that may be classified in at least three general categories: (1) operational attributes 102, relating to the capabilities of the target component, its interaction with the rest of the system, and its functional implementation, (2) installation attributes 104, relating to the physical implementation and installation of the target component, and (3) business attributes 106 that relate to the business aspects of using the target component, such as its cost. Clearly, in most cases, the operational attributes 102 are the most important during the utilization of the RDPI system 10 in the design, prototyping and implementation process.

The operational attributes 102, may include, but are not limited to, attributes such as a list of the target component's capabilities (i.e., the list of actions the target component can perform), the capacity of one or more capabilities of the target component (such as data storage memory, processing power, data transmission rate, etc.), the communication protocols and formats usable by the target component, the component's operational parameters (such as specific control/configuration settings, required signals, etc.), I/O data parameters that determine what data or instructions the target component can receive and what outputs it generates, as well as other attributes, such as rules and templates. The operational attributes 102 rules may include restrictions on use with other specific target components, or a requirement of one or more additional target components being connected thereto, or used elsewhere in the target system. The templates may include identification of partial instruction modules available at the development system 12, that when combined with additional information determined after the visual system model is partitioned, can be automatically converted by the system 12 into ready-to-use instruction modules, such as executable code, which may be loaded into the actual target component during implementation.

The installation attributes 104 may include physical characteristics of the target component, such as its dimensions, weight, noise and/or pollution output, resource (fuel, energy, etc.) consumption, or the like, and may also include installation rules such as specific installation and/or safety requirements. Finally, business attributes 106 may include the cost of the target component as well as its availability for use with the target system (lead time, stock status, etc.) to enable the user to incorporate business issues during the prototyping process. Of course, the target attribute record 100 may include other attributes of the above-described or other categories.

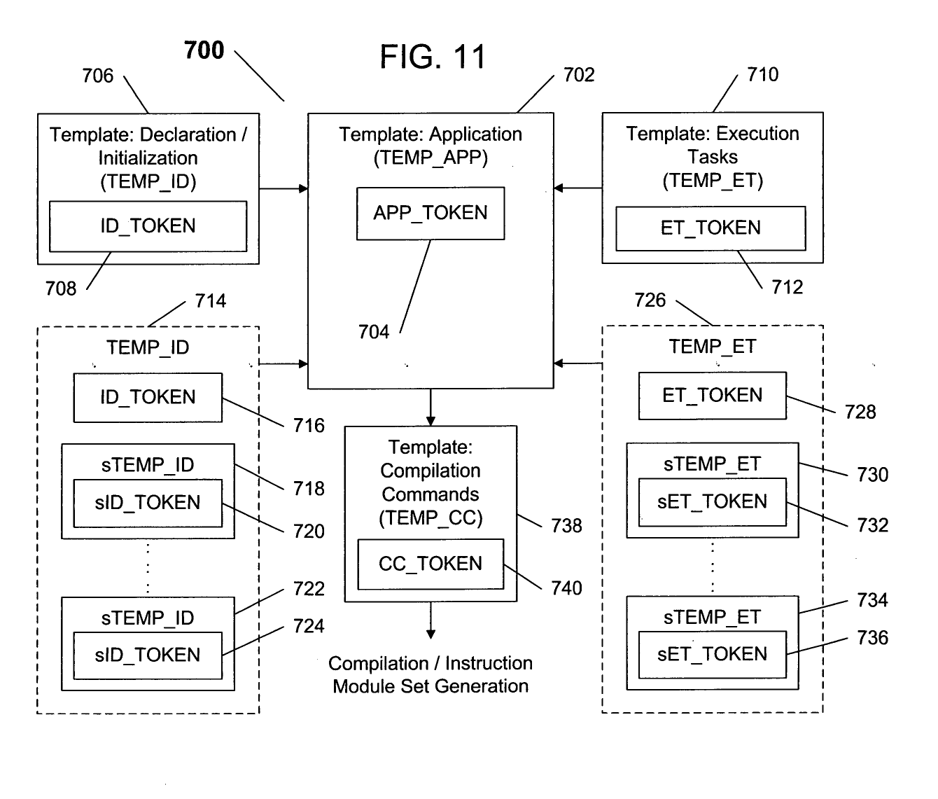

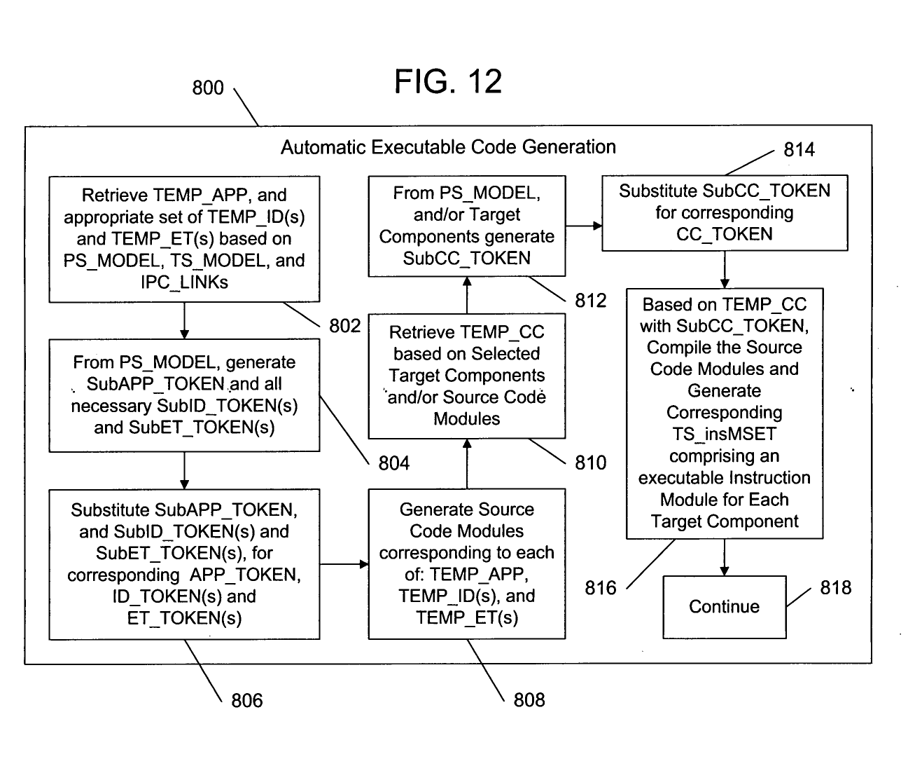

It should be noted, that the contents-of the target attribute record 100 may vary greatly in scope and quantity between different target components, but should at least include the minimum attributes necessary for the user to make partition assignment and related decisions during utilization of the RDPI system 10 (as described in greater detail below in connection with FIGS. 5 through 7), and one or more template attributes necessary to perform automatic instruction module generation for the target component (as described in greater detail below in connection with FIGS. 11 and 12).

As noted above, in connection with FIG. 1, the key novel features and operation of the RDPI system 10 are controlled and configured by performance of one or more inventive processes implemented as data processing tasks (such as stand-alone programs, macros, applets, program modules, programs, or any other form of executable task performance instruction sets), that are executed by the development system 12 during utilization by the user thereof.

Nevertheless, for the sake of clarity, and without any limitation from the nomenclature, the core data processing task responsible for enabling the key operations of the inventive RDPI system 10, that is performed by the development system 12, will hereinafter be referred to as a “main program”, while additional data processing tasks will hereinafter be referred to as a “program modules”.

Referring now to FIGS. 5 through 7, a main process diagram 200 and sub-process diagrams 300 and 400, are shown. In accordance with the present invention, the main process diagram 200 and sub-process diagrams 300 and 400 are representative of a combination of user actions, as well as actions performed by a main program and related program modules, that are executed by the development system 12 of FIG. 1 during the utilization of the RDPI system 10.

It should be noted, that only those steps necessary or desirable for RDPI system 10 operation are shown. It is contemplated that execution of application programs and program modules as implemented in various types or configurations of development systems 12, may involve numerous conventional processes and steps not shown here because they are not part of the present invention.

Because of numerous abbreviations used in FIGS. 5 to 7, Table 1 below provides a useful definition guide to the terms used in the respective figures.

TABLE 1
(Terms in FIGs. 5 to 7)

| Abbreviation | Definition |
|---|---|
| PS_MODEL | Partitioned System Model |
| TS_MODEL | Target System Model |
| PART | Partition |
| TS_insMSET | Implementation —ready Instruction Module Set |
| IPC_LINK | Inter-Partition Communication Link |
| DS_Items | Set of Designed System Items (PS_MODEL, |
| | TS_MODEL, and TS_insSET) |
| | for a particular designed system |
| DSM_SET | Set of two or more DS_Items in a project with multiple |
| | design systems and thus multiple DS_Items |

The process 200 of the present invention begins at a step 202 where the user is provided a with a visual system model of a task control and/or performance system or apparatus, representative of the desired functionality of the target system under development that has been previously designed (by the user or by others) and that is in an interactive graphical format that may be altered or modified by the user and the processes 200-400. Advantageously, the process 200 is applicable to any visual system model that may be created with any form of visual design and/or modeling tools. In fact, optionally, the main program and program modules of the processes 200-400, may even be implemented as “add-ons” to any conventional visual design and/or modeling system or environment, for example as “applets” or “toolboxes.” This enables the user to utilize a familiar design environment, commands, and user-interface, while at the same time taking full advantage of the novel features and capabilities of the RDPI system 10. Optionally, conversion tools may be utilized to convert the visual system model into a format with which the processes 200-400 can interact. For example, if the visual system model was developed on one system using modeling software A, and then transmitted to another user for prototyping using the development system 12 with modeling software B, the user at system 12 can convert the visual model into a format acceptable to software B and begin the prototyping process. This flexibility in working with other available or custom modeling systems and design tools in any environment or operating system with only minor adjustments, makes the novel RDPI system 10 truly platform and vendor-independent.

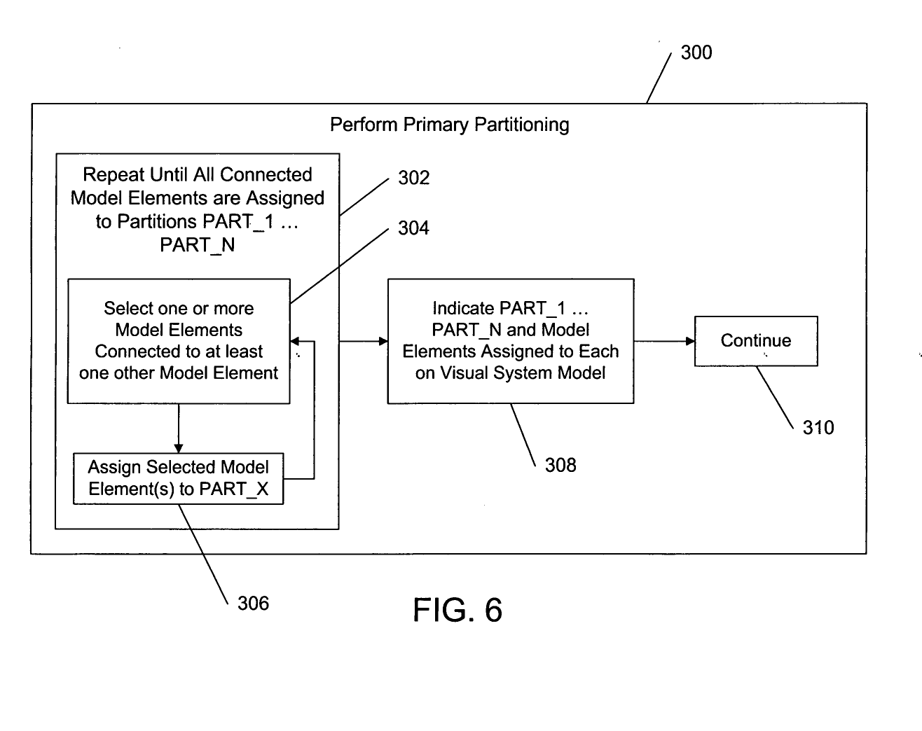

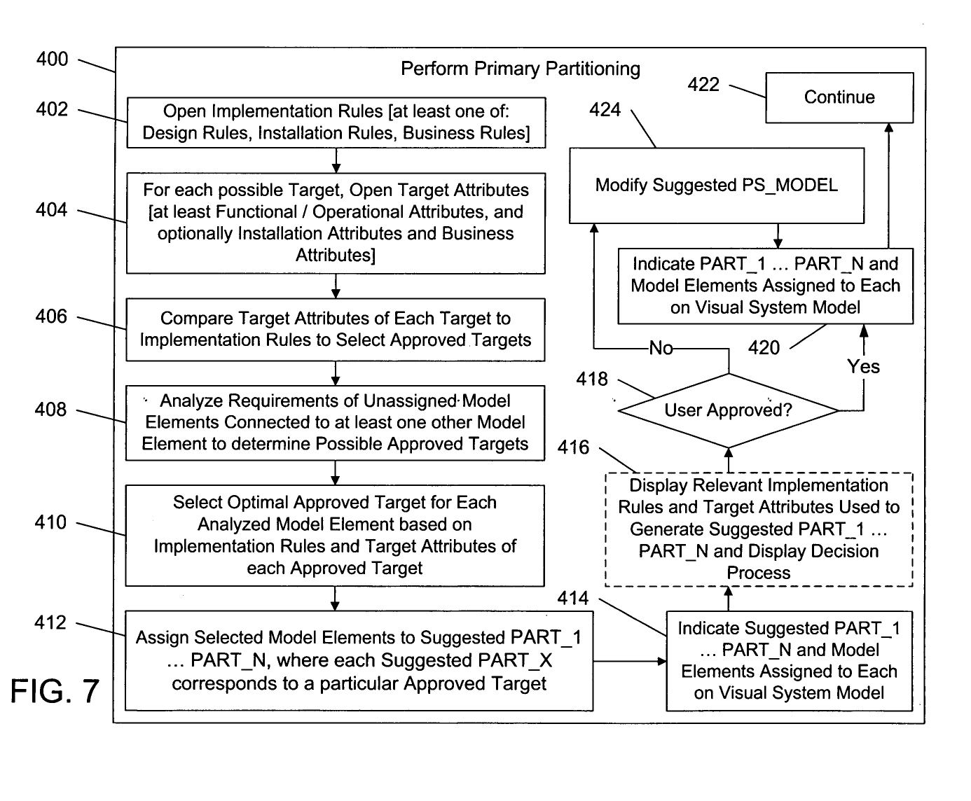

At a step 204, the user (or the main program) perform the core task of partitioning the visual system model into partitions, each with one or more model elements (e.g. blocks of a block diagram, etc.) suitable for future implementation in various target components of the target system being designed. While one of the key features of the present invention is to give the user an ability to easily define partitions as a matter of their design requirements, optionally, the primary partitioning task and several other steps of the process 200 may be performed automatically by the development system 12. Thus, in one embodiment of the present invention shown as the process 300 in FIG. 6, the primary partitioning process can be implemented under the user's complete supervision, while in another embodiment, shown as the process 400 in FIG. 7, the partitioning process along with other process 200 steps may be automatically performed by the development system 12, and then presented to user for approval or further modification.

Referring now to FIG. 6, a first embodiment of the primary partitioning process is shown as a process 300. Before discussing the process 300 in greater detail, it would be helpful to illustrate the various steps by referring to an example of partitioning an exemplary visual system model such as a visual system model 500 shown in FIG. 8. The model 600, an exemplary visual system model for a target system that transports a product to an inspection area where the product is analyzed for defects, discarded if defects are found, and placed into finished storage otherwise. The model 500 has a variety of model elements that represent particular actions and data collection tasks, such as obtaining the speed of a conveyor or controlling product acquisition and movement (e.g. by an industrial robot.).

In some cases, a visual system model may have one or more model elements that are not connected to any other elements or may have a one or more groups of two or more model elements separate from the rest. These “floating” elements represent the portions of the system model which do not have a physical connection to other elements in the target system but that can still interact wit the system in other ways. For example, the model 500 includes two such model elements. For example, one of them is responsible for controlling lighting in the facility where the target system is installed that can affect the model element (ME_DQ) which may be a camera.

The process 300 which begins by performing step 302 until all model elements of the visual system model that are connected to other model elements, have been assigned to a specific partition PART_1 to PART₁₃ N, where N is the total number of partitions in the system. Referring now to FIG. 9, the model 500 of FIG. 8 is shown by way of example as a model 600 partially partitioned into PART_1 to PART_7. The choice of assigning specific elements to various partitions is a matter of design choice for the user and may depend on many factors, including, but not limited to: the nature of the desired target system, the available target components for which the partitions are being created, and so on.

At a step 304, the user selects one or more model elements connected to at least one other model element, and assigns them to a particular partition (PART_X) at a step 306, repeating steps 304, 306, as noted above, until all model elements that were connected to other elements have been assigned to PART_1 to PART_N.

The specific manner in which model elements are assigned to desired partitions may be determined as a matter of design choice or convenience (for example there are many interface and input differences between a development system 12 that is a pocket computer or a system 12 that is a desktop workstation with a large display and key board. Preferably, the assignment step 304 is performed using a graphical user interface (GUI) (not shown) of the output system 24 (e.g., of a monitor), where the model elements may be assigned to each partition with a graphical selection tool, such as a “lasso”, through “clicking” on an element with a pointer and selecting a command in a dialog box, by placing markers on the links connecting the model elements to one another to separate one or more model elements from the rest of the system and form a partition around them, or in any other manner available or convenient to the user. For example, in FIG. 9, these markers are shown as “P” blocks placed on various links connecting the model elements. At a step 306, the system 12 visually indicates the defined PART_1 to PART_N on the visual system model and returns to the process 200 at a step 310.

At a test 206, it is determined (by the user, or optionally by system 12) if there are any “floating” model elements unassigned to any defined partition. If such elements exist, at a step 208, the user can repeat the partitioning process 300 for these elements or optionally assign them to one or more of the existing partitions as a matter of design choice. The secondary partitioning step is illustrated in FIG. 10 which shows the partially partitioned model 600 of FIG. 9 as a fully partitioned model 650 with the floating model elements assigned to PART_8 and PART_9. Otherwise, at a step 210, the user, working with a partitioned system model (PS_MODEL) manually, or with optional assistance of the system 12, selects particular target components, taking their target attribute records into account, for the partitions defined in the previous steps and assigns the selected target components to the desired partitions. As previously discussed in connection with FIG. 6, the assignment may be performed using the GUI (for example through dialog boxes) or “drag-and-drop” operations, or in any other manner available or convenient to the user.

At a step 212, the user, or the system 12, ensure that proper inter-partition communication links (IPC_LINKS) are formed in the TS_MODEL based on the requirements of links and function, communication, and signal flows in the PS_MODEL, for example to ensure that the target components selected at the step 210 can properly work and communicate with one another and any remote system as necessary. At an optional step 214, the system 12 may verify the integrity of the TS_MODEL, for example to ensure that the IPC_LINKS were properly selected at the step 212, and if the results are determined to be unsatisfactory at an optional test 224, proceed to an optional test 206 where the PS_MODEL may be modified by the user, the system 12 returns to the step 210 for re-assignment of target components and modification of the TS_MODEL.

If the results are satisfactory, at this point the user has created a TS_MODEL that may be readily utilized to generate implementation instruction program modules for use in production or emulation target systems, and the process 200 may end at a step 228, where the system 12 outputs the a design system model set (DSM_SET) that includes the verified versions of the PS_MODEL and TS_MODELS. The DSM_SET may then be used by another user at system 12 or at another development system to edit the one or more contents of the DSM_SET, to incorporate the DSM_SET in a larger DSM_SET along with other DSM_SETs, or automatically generate the necessary corresponding executable target system instruction module set (TS_insMSET) for target system implementation.

Alternately, (and preferably in many cases) optional steps 216 and 218 may be performed by the system 12 to automatically generate the necessary TS_insMSET such that the user may readily begin target system implementation without writing a single line of code.

At a step 216, the system 12 automatically generates the necessary executable instruction modules (i.e., the TS_insMSET) based on the target components in the TS_MODEL, but also taking into account the IPC_LINKS and specific requirements embodied in the PS_MODEL that could not be translated directly into the TS_MODEL by the partitioning and target component assignment operations. Any automatic code generation technique capable of meeting the above requirements may be readily utilized at this step to generate the TS_insMSET. However, preferably, a novel inventive code generation process 800 of the present invention, as discussed below in connection with FIGS. 11 and 12 may be advantageously utilize to provide an unprecedented level of automation and user independent functionality. At the optional step 218, the system 12

At an optional step 220 provides the TS_insMSET to the target system (for example, the target system 14 of FIG. 1) via the communication link 16, and distributes appropriate executable instruction modules to corresponding target components. At an optional step 220, the user may instruct the system to selectively repeat at least a portion of previous steps 202 to 218, a predetermined amount of times to generate one or more additional PS_MODELs, TS_MODELs, and optionally corresponding TS_insMSETs, and then organizes them in one or more DSM_SETs which are then provided at the step 228. If more than one DSM_SET is created, an optional relationship marker REL_Inf, may be stored in each DSM_SET to indicate that the DSM_SETS are part of the same project. This may be useful if the desired target system is comparable to the target system 70 of FIG. 3 where four separate target systems 72, 74, 46, 78, of various types are contemplated. This step thus enables the user to design multiple variations of target systems from a single visual system model. If optional steps 216 and 218 were performed, at an optional step 222, the user may instruct the system 12 to perform a simulation of the implemented target system and optionally monitor the results or manage the system. If the optional step 220 was performed the user may also experiment by comparing utilization of various target components under the same or different scenarios or conditions.

Referring now to FIG. 7, a second embodiment of the primary partitioning process is shown as an automated process 400, The process 400 begins at a step 402, where the system 12 retrieves at least one previously developed implementation rule from a group of design rues, installation rules, business rules, that include specific predetermined parameters, ranges, or values of target component attributes, that correspond to attributes of desirable target components for use with the target system being developed. One or more of these rule sets may be previously configured for use with design of particular types or classes of target systems, and may also change over time as design requirements shift. Alternately, the rules may be implemented as expert systems.

At a step 404, the system 12 opens the target attribute records (such as the attribute record 100 of FIG. 4) for each possible target component, preferably opening the category(ies) of attributes matching the rule(s) opened at the step 204. At a step 406, the system 12, compares target attributes of each possible target to open implementation rules to select approved targets components that meet or exceed the requirements imposed by the rules.

At a steps 408 to 412, the system 12 analyzes the requirements of unassigned model elements in the visual system model and then assigns specific model elements to optimal approved targets. At a step 414, the system 12 visually indicates the results of the automatic partitioning process to the user as a suggested PS_MODEL, and at an optional step 416 displays to the user at least a portion of the information used by the system 12 at the steps 402 to 412 so that the user can ensure that the system 12 is performing the process 400 correctly and/or optimally. If the user approves the suggested PS_MODEL at a test 418, the system 12 visually indicates PART_1 to PART_N on the visual system model to form PS_MODEL and continues to the step 212 of FIG. 1. Otherwise, at a step 424, the user may manually, or with assistance of the system 12 reassigned modify the suggested PS_MODEL and then proceed to the step 420. Optionally, when the system 12 continues from the step 222, it may automatically continue to perform one or more of the steps 212 and through 222 with as much (or as little) input and control from the user as desired.

As can be seen from the process 200 of FIG. and the processes 300 and 400 of FIGS. 6 and 7, by utilizing the inventive RDPI system 10, the user can easily return to a previously created DSM_SET and freely modify any aspect of its contents, for example by adding more model elements to the PS_MODEL (and assigning them to existing partitions and/or creating new partitions), by modifying the TS_MODEL by shifting one or more partitions to different target models, or by changing, adding or deleting one or more of the target models. While with previously known systems, such changes would require the user to spend a great deal of time and resources to redesign the visual system model and write new program code, in accordance with the present invention, the user is able to many any changes to various aspects of the designed system and then quickly and easily generate new executable code modules for rapid implementation in a new target system or systems. These kinds of capabilities allow a revolutionarily level of “future-proofing” with respect to constant advancements in technology, so that the user of the inventive RDPI system 10 can always readily upgrade or change a system designed years ago as new components become available or if the target system requirements change.

Referring now to FIGS. 11-12, as noted above in connection with the description of optional steps 216 and 218 of FIG. 5, while any available automatic code generation technology may be used, or adapted for use by, the inventive RDPI system 10, a novel automatic program generation tool, such as an automatic executable code generation process 800 of FIG. 12 may be advantageously utilized.

Because of numerous abbreviations used in FIGS. 11-12, Table 2 below provides a useful definition guide to the terms used in the respective figures.

TABLE 2
(Terms in FIGs. 11 to 12)

| Abbreviation | Definition |
|---|---|
| TEMP_ID | Declaration/Initialization Template |
| ID_TOKEN | Token of the Declaration/Initialization Template |
| sTEMP_ID | Declaration/Initialization sub-Template |
| ID_TOKEN | Token of the Declaration/Initialization sub-Template |
| TEMP_APP | Application Template |
| APP_TOKEN | Token of the Application Template |
| sTEMP_APP | Application sub-Template |
| sAPP_TOKEN | Token of the Application sub-Template |
| TEMP_ET | Execution Tasks Template |
| ET_TOKEN | Token of the Execution Tasks Template |
| sTEMP_ET | Execution Tasks sub-Template |
| sET_TOKEN | Token of the Execution Tasks sub-Template |
| TEMP_CC | Compilation Commands Template |
| CC_TOKEN | Token of the Compilation Commands Template |
| sTEMP_CC | Compilation Commands sub-Template |
| sCC_TOKEN | Token of the Compilation Commands sub-Template |
| sub-“TOKEN” | Substitute tokens for different templates that replace their |
| | corresponding default token and enable the template to be |
| | compiled into an executable instruction set |

While the process 800 refers to “automatic executable code generation”, it should be understood that the process 800 may be readily utilized to generate any and all instruction sets and related configuration data necessary for enabling the target system executes the received TS_insMSET to implement the desired DSM_SET, and thus to accomplish the full purpose of the RDPI system 10. Thus the process 800 may produce TS_insMSET that includes, without limitation, one or more executable programs, program modules, drivers, program objects, dynamic link libraries, initialization variable values, communication protocol settings, and so on.

In describing the novel process 800, it would be helpful to first define the usage of the terms “templates” and “tokens” with respect to the inventive system. A template is a partially written or completely written code that contains tokens. A token is a piece of identifiable information in the template that need not follow the programming language syntax or semantics. Therefore, the template file cannot be compiled to generate an executable with its default token. A matching substitute token with appropriate information based in part on one or more of the designed system parameters is necessary to make the template “active”—i.e. ready for compilation and conversion into executable code.

In summary, in executing the novel process 800, in steps 802 to 816 of FIG. 12, the system 10 retrieves the appropriate templates to implement the desired target system from the various models and previously generated information, and then obtains the necessary substitute tokens from the TS_MODEL, PS_MODEL, and IPC_LINKS., substitutes them for corresponding default token in the various templates to prepare them for compilation and then and then generates source code modules therefrom arranged in accordance with the active TEMP_APP, and finally generates the executable TS_insMSET in accordance with an active TEMP_CC, thus providing the inventive system 10 with automatic instruction set generation capabilities and enabling implementation of the developed system in a target system without requiring the user to write any code.

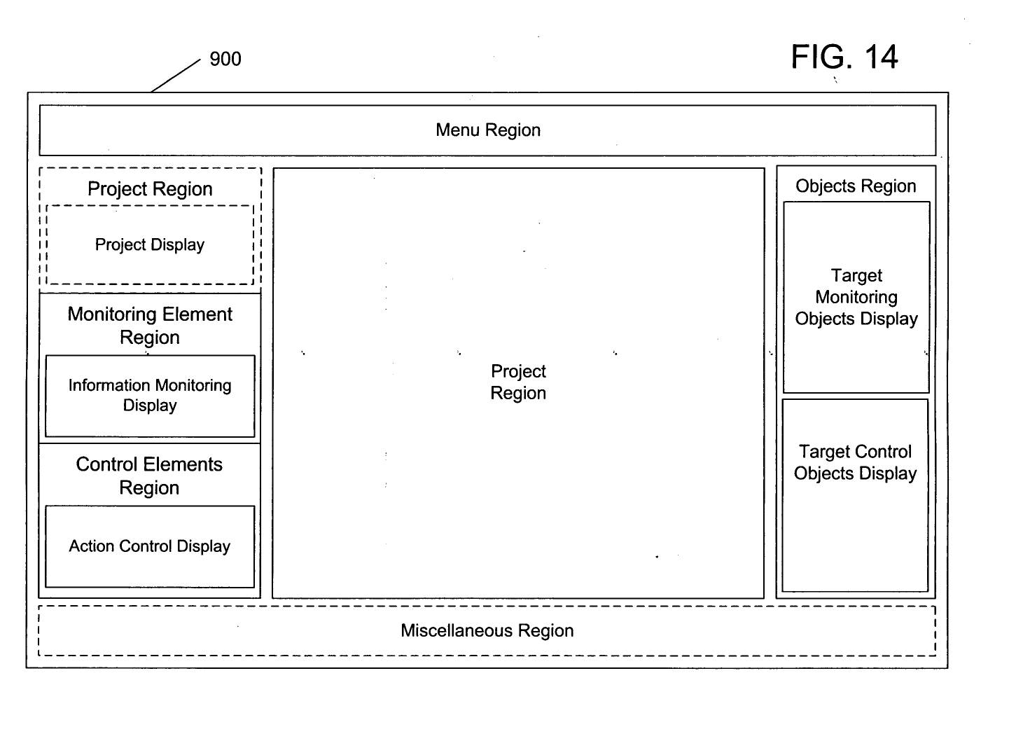

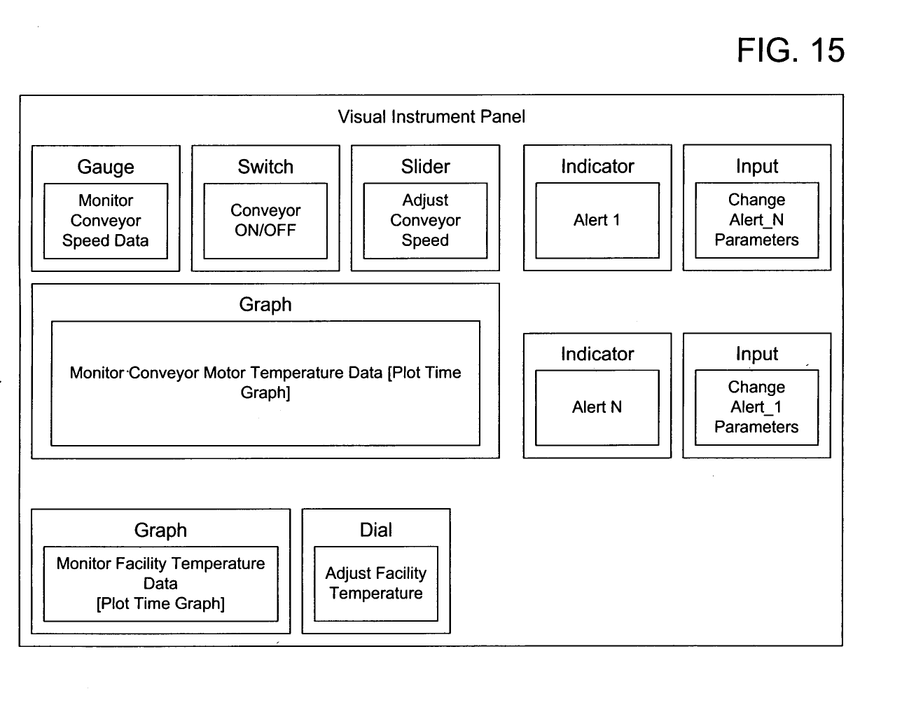

The various features of the techniques of the present invention also greatly facilitate local or remote monitoring and/or management of a target system, for example, while performing simulations during the design/prototyping process, for remote system troubleshooting, maintenance, or technical support, or when the target system is being used in its ordinary course. While various remote target monitoring/management systems may be used as a matter of design choice or necessity, the development system 12 of the present invention may be advantageously provided with a novel interactive user interface, at its output (i.e. display) system 24 with novel tools and functionality that enable the user to readily design an interactive reconfigurable visual instrument panel for monitoring and/or management of one or more remote target systems or devices. An exemplary visual instrument system design interface 900 is shown in FIG. 14 and includes regions for displaying monitoring and control elements as well as a region of graphical monitoring control objects. Any element may be linked to an object of an appropriate type (for example by “drag-and-drop” or otherwise) for monitoring and/or managing any aspect of the remote target system in real-time. The active objects are then arranged into a desired panel in the project region. Alternate embodiments of the interface 900, include, but are not limited to multiple display configuration for collective monitoring of one or more target systems by geographically dispersed users, or configuration of specific instrument panels for benchmarking multiple variants of the same system at once. An exemplary visual instrument panel 950 for monitoring/management of the system of FIG. 8, is shown in FIG. 15

Accordingly, the inventive system and method enable a user to rapidly move from a visual system model, previously designed using any system modeling application, to a ready for use prototype operational system model, and optionally automatically generate corresponding instruction modules therefrom that may be readily loaded into a desired target system for simulation and/or for actual production use, all without writing a single line of programming code. Moreover, after the prototype system has been designed, the RDPI system of the present invention enables the user to easily make any changes, and refresh the prototype system without having to write code, or re-design the prototype system from scratch, and/or monitor and manage one or more the target systems remotely in real-time.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

1. A data processing system for enabling a user to rapidly develop a task performance system for performing at least one predefined task, and being capable of implementation in a corresponding physical target system, the data processing system being used in conjunction with a visual system model representative of at least one aspect of the desired task performance system, the visual system model including a plurality of model elements, each representative of at least a portion of each said at least one aspect of the task performance system, and also including at least one communication connection between at least two of the plural model elements, the data processing system comprising:
a plurality of target components, each plural target component having at least one predefined target attribute representative of a particular information item relating to utilization thereof;
sorting means for sorting, in accordance with at least one predefined design protocol, said plural model elements into a plurality of partitions, such that each said plural partition contains at least one model element to form a visual partitioned system model; and
assignment means for assigning each said plural partition to one of said plural target components to form an interactive visual target system model, wherein said partition and said target models are optimized for generation of an instruction set therefrom, thereby enabling the physical target system to be configured to perform said at least one predefined task if said instruction set is generated and then executed therein.

2. The data processing system of claim 1, further comprising:
automatic code generation means for automatically generating said instruction set from said partition system model and from said target system model.

3. The data processing system of claim 2, further comprising execution means for causing the target system to execute said instruction set to thereby implement the task performance system.

4. The data processing system of claim 3, further comprising:
control means for selectively automatically controlling at least one of said sorting means, said assignment means, said automatic code generation means, and said execution means.

5. A data processing method of enabling a user to rapidly prototype and implement a task performance system for performing at least one predefined task, using a visual system model having a plurality of model elements representative of operations and parameters that must be implemented in a plurality of target components of a target system, to perform the at least one predefined task, the data processing method comprising the steps of:
(a) separating said plural model elements into a plurality of partitions;
(b)establishing at least one communication link between two or more of said plural partitions;
(c)assigning each said plural partition to a corresponding plural target component to generate a target system model; and
(d) forming a prototype model system representative of said plural partitions, said at least one communication connection, and said target system model.

6. The data processing method of claim 5, further comprising the steps of:
(e) automatically generating an instruction set corresponding to said prototype system model;
(f) delivering said instruction set to the target system; and
(g) executing said instruction set at the target system thereby implementing the task performance system.

7. A data processing method for enabling prototyping, by a user, of a task performance system operable to perform at least one predefined task, and intended for implementation in a plurality of target components of a target system, comprising the steps of:
(a) providing a visual system model, representative of desired functionality of the task performance system, said visual system model comprising a plurality of model elements, each said plural model element being representative of a portion of said desired functionality, and
(b) partitioning of said plural model elements into a plurality of system partitions, each said plural system partition corresponding to one of said plural target components that is at least capable of implementing said desired functionality of said plural model elements in said corresponding plural system partition.

8. The data processing method of claim 7, wherein at least two of said plural model elements are connected to one another by at least one element link, and wherein said step (b) comprises the step of:
(c) assigning, each plural model element to one of said plural system partitions in accordance with a predefined design guideline.

9. The data processing method of claim 8, wherein each plural target system component comprises at least one of an operational, business, or installation attribute, and wherein said predefined design guideline is at least one of:
a desired or mandatory value of at least one of operational, installation, or business attribute of at least one of the plural target components, and
design, installation, and business rules for the task performance system.

10. The data processing method of claim 9, wherein said operational attribute is at least one of: target system component functional capabilities, target system component performance characteristics, target system component capacity, target system component communication capabilities, target system component operational parameters, target system component input and output data parameters, target system component operational rules, and at least one target system component instruction template for enabling automatic instruction module generation therefor.

11. The data processing method of claim 9, wherein said installation attribute comprises at least one of: target system component physical characteristics, target system component resource consumption characteristics, target system component environmental interaction characteristics, and target system component installation rules.

12. The data processing method of claim 9, wherein said business attribute comprises at least one of: target system component cost, target system component cost-of-use, and target system component availability.

13. The data processing method of claim 8, wherein said predefined design guideline comprises: a presence of said at least one element link between particular plural model elements.

14. The data processing method of claim 13, wherein said step (c) comprises the step of
(d) assigning at least a portion of the plural model elements to said plural system partitions, by selectively marking said at least one element link for each plural model element having said at least one element link to another plural model element, such that each said plural system partition comprises one of: a plural model element having a single marked element link, or at least two plural model elements having at least one unmarked element link therebetween.

15. The data processing method of claim 14, wherein said step (d) further comprises the step of:
(e) when at least one model element has not been assigned to any of said plural system partitions at said step (d), selectively assigning said at least one unassigned model element to one of at least one existing plural system partition, and at least one new plural system partition.

16. The data processing method of claim 8, wherein said step (c) is performed by at least one user, each utilizing a data processing system comprising a graphical user interface.

17. The data processing method of claim 8, wherein said step (c) is performed automatically by said at least one data processing system.

18. The data processing method of claim 8, wherein said step (c) is performed automatically by at least one data processing system, further comprising the step of:
(f) prior to said step (b), providing said predetermined design guideline to said at least one data processing system.

19. The data processing method of claim 18, wherein said step (c) comprises the steps of:
(g) automatically identifying optimal plural target system components in accordance with said predefined design guideline;
(h) automatically determining optimal plural system partitions, corresponding to said optimal plural target system components; and
(i) automatically assigning, each plural model element to one of said optimal plural system partitions.

20. The data processing method of claim 19, further comprising the step of:
(j) prior to said step (i), displaying, to the user, results and operation of each of said steps (g) and (h),
(k) when an approval is received, proceeding to said step (i), and
(l) when said approval is not received, selectively controlling operation by the user of at least one of said steps (g) and (h) until said approval is received and then proceeding to said step (i).

21. The data processing method of claim 13, further comprising the step of:
(m) after said step (b), generating, in accordance with said design guideline from said plural system partitions and said at least one model link, a partition system model, representative of said desired functionality of the task performance system, and of separation of portions of said desired functionality for intended implementation in individual plural target components.

22. The data processing method of claim 21, further comprising the step of:
(n) after said step (m), generating a target system model from said partition system model, by selectively assigning a particular plural target component to each corresponding plural system partition of said preliminary partition system model in accordance with said design guideline.

23. The data processing method of claim 22, further comprising the steps of:
(o) generating a final target system model by selectively defining at least one communication link between a least a portion of said plural target components thereof; and
(p) generating a final partition system model by selectively defining at least one communication link between a least a portion of said plural system partitions thereof.

24. The data processing method of claim 23, further comprising the step of:
(q) verifying an integrity and functionality of said final target system model.

25. The data processing method of claim 23, further comprising the step of
(r) automatically generating a plurality of instruction modules, based on at least one of said final target system model and said final partition system model, such that, when executed by said plural target components, the task performance system is implemented in the target system in accordance with said design guideline.

26. The data processing method of claim 25, further comprising the step of:
(s) delivering said plural instruction modules to corresponding plural target system components for execution during target system operation.

27. The data processing method of claim 23, further comprising the step of:
(t) after said step (p), providing an alternate design guideline to said design guideline utilized at said step (n), and performing said steps (n), (o), (p), (r) and (s) utilizing said alternate design guideline.

28. The data processing method of claim 27, further comprising the steps of:
(u) selectively repeating said step (t) for a predetermined number of iterations to produce a corresponding plurality of final partition and target system models; and
(v) assigning a unique identifier to each set of said plural final partition system model and said plural final target system models, representative of a specific design guideline used in generation thereof.

29. The data processing method of claim 23, further comprising the step of:
(w) generating a project summary record comprising at least information sufficient to identify at least one of said desired task performance system, any user involved in the work on said task performance system, said target system and any necessary instructions to communicate therewith, said plural system partitions and communication links therebetween in said final partition system model, said at least one plural model element in each said plural system partition and said target components and communication links therebetween in said final target system model, and said design guideline.

30. The data processing method of claim 29, further comprising the steps of:
(x)transmitting said project summary record to a different data processing system; and
(y) re-generating said final partition and target system models at said different data processing system from said project summary record.

31. The data processing method of claim 26, further comprising the step of:
(z) after said step (s), executing, by the target system components, said plural instruction modules to implement the task performance system in the target system.

32. The data processing method of claim 31, further comprising the step of:
(aa) monitoring the target system and the plural target system components during performance of said step (z) to verify whether implementation of the task performance system in the target system has been successful.

33. The data processing method of claim 31, further comprising the step of:
(bb) selectively modifying said design guideline, and selectively repeating at least a portion of said steps (b) to (aa), to produce a different implementation of said task performance system.

34. The data processing method of claim 33, further comprising the step of:
(cc) prior to said step (bb), selectively providing at least one New target system component.

35. The data processing method of claim 7, wherein at least one of the plural target system components is configured as an emulation system component.

36. The data processing method of claim 28, further comprising the steps of:
(dd) assigning a unique project identifier to said plural final partition and target system models, such that each said plural final partition and target system model is identified as belonging to a particular project corresponding to said project identifier.

37. The data proccessing method of claim 7, wherein said step (a) comprises the step of:
(ee) generating said visual system model by at least one user.

38. The data processing method of claim 7, wherein said steps (a) and (b) are performed utilizing different data processing systems.

39. The data processing method of claim 23, wherein at least one of said steps (m), (n), (o) and (p) are performed utilizing different data processing systems.

40. The data processing method of claim 23, wherein at least one of said steps (b), (m), (n), (o) and (p) are performed utilizing a graphical user interface.
